(19) United States
(12) Patent Application Publication
(10) Pub. No.: US 2025/0078062 A1
(43) Pub. Date: Mar. 6, 2025

(54) FEEDBACK FOR TRANSACTION RECIPIENTS

(71) Applicant: Motorola Mobility LLC, Chicago, IL (US)

(72) Inventors: Krishnan Raghavan, Bangalore (IN); Vignesh Karthik Mohan, Bangalore (IN); Rahul Sahadevan, Bengaluru (IN)

(73) Assignee: Motorola Mobility LLC, Chicago, IL (US)

(21) Appl. No.: 18/238,679

(22) Filed: Aug. 28, 2023

(51) Int. Cl. G06Q 20/32; G06Q 30/0601

(52) U.S. Cl. CPC G06Q 20/3267; G06Q 20/3223; G06Q 30/0641

(57) ABSTRACT

Techniques for feedback for transaction recipients are described and are implementable to enable users to provide transaction feedback for transaction recipients and the transaction feedback to be converted into recipient feedback for the transaction recipients. In implementations, a user can be presented with indicia of transaction feedback with a transaction recipient at various points in a data transaction process. The user can interact with the indicia of transaction feedback to indicate transaction feedback for a data transaction with the transaction recipient. The transaction feedback can be aggregated with other transaction feedback for the transaction feedback to generate recipient feedback for the transaction recipient.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without challenges. For instance, users can utilize finance applications to perform transactions with parties about which little or no information is known.

### BRIEF DESCRIPTION OF THE DRAWINGS

Aspects of feedback for transaction recipients are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of feedback for transaction recipients can be implemented.

FIG. 2a depicts aspects of an example system for feedback for transaction recipients in accordance with one or more implementations.

FIG. 2b depicts further aspects of the example system for enabling transaction feedback to be presented.

FIG. 3 depicts an example payment indicator in accordance with one or more implementations.

FIG. 4 depicts an example payment graphical user interface (GUI) in accordance with one or more implementations.

FIG. 5 depicts an example transactions GUI in accordance with one or more implementations.

FIG. 6 depicts an example feedback indicator in accordance with one or more implementations.

FIG. 7 depicts an example feedback GUI in accordance with one or more implementations.

FIG. 8 depicts an example payment GUI in accordance with one or more implementations.

FIG. 9 illustrates a flow chart depicting an example method for feedback for transaction recipients in accordance with one or more implementations.

FIG. 10 illustrates a flow chart depicting an example method for feedback for transaction recipients in accordance with one or more implementations.

FIG. 11 illustrates various components of an example device in which aspects of feedback for transaction recipients can be implemented.

### DETAILED DESCRIPTION

Techniques for feedback for transaction recipients are described and are implementable to enable user feedback regarding data transactions (e.g., payment transactions) with transaction recipients to be collected, aggregated, and converted into user feedback for the transaction recipients. In at least one implementation a transaction recipient represents an entity that provides products (e.g., goods and/or services) for purchase. Further, a transaction recipient may not maintain a dedicated online presence via which information (e.g., feedback) regarding the transaction recipient can be obtained. A transaction recipient, for instance, represents an entity such as a mobile merchant (e.g., a food truck, a transient market seller, a produce stand, etc.) that may accept digital payments but that does not have a dedicated online presence (e.g., a website) via which information about the transaction recipient can be obtained.

For instance, the described techniques enable different users to provide transaction feedback for different data transactions with a transaction recipient. A transaction service can process the transaction feedback to generate recipient feedback for the transaction recipient. For instance, transaction feedback for individual data transactions with a transaction recipient can be aggregated and converted into recipient feedback for the transaction recipient. The recipient feedback can be provided to users in different ways, such as via data transactions initiated with the transaction recipient, via an express request for recipient feedback, via a data transaction summary, etc.

Accordingly, techniques described herein enable users to provide and receive transaction feedback for transaction recipients. In implementations, a data transaction represents a payment transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling user feedback for transaction recipients, the described techniques can conserve user and system resources (e.g., memory, processor bandwidth, network bandwidth, etc.) that may otherwise be used to perform undesirable data transactions, and thus the described techniques can improve the operation of computing devices and data networks. Further, by enabling transaction data for data transactions to be aggregated across different data networks, the described techniques can mitigate data aggregation and data flow problems that may occurs across data networks.

While features and concepts of feedback for transaction recipients can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

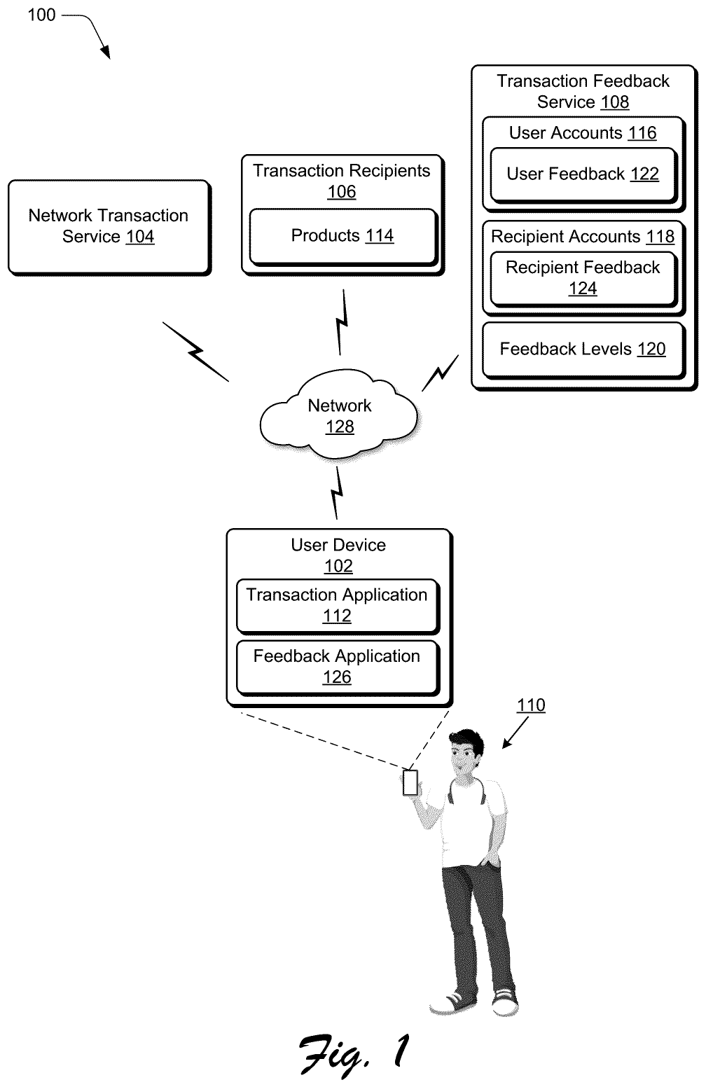

FIG. 1 illustrates an example environment 100 in which aspects of feedback for transaction recipients can be implemented. The environment 100 includes a user device 102, a network transaction service 104, transaction recipients 106, and a transaction feedback service 108. The user device 102 represents a device that can be used by a user 110 to perform and manage different data transactions, e.g., finance transactions such as purchasing goods and services.

The network transaction service 104 represents a network-based service that is accessible to the user device 102 to perform different data transactions. The network transaction service 104 can be implemented by various entities, such as a banking entity, a digital payment service, an enterprise entity, a trading entity, a data storage and/or management entity, and/or combinations thereof. The user 110, for instance, can utilize a transaction application 112 on the user device 102 to access the network transaction service 104 to perform different finance transactions, such as to transfer value amounts (e.g., monetary values) for different purposes, e.g., to purchase goods and services. The transaction application 112, for example, represents functionality that enables various finance-related transactions to be performed via the user device 102, including access to the network transaction service 104.

The transaction recipients 106 represents entities with which the user device 102 can engage in a data transaction. The user device 102, for instance, can initiate an exchange of data with the transaction recipients 106. For example, the transaction recipients 106 can provide products 114 (e.g., goods and/or services) to the user 110 and in exchange the user device 102 can cause a transfer of data (e.g., data representing an exchange of value) to the transaction recipients 106. In at least one implementation the data exchange between the user device 102 and the transaction recipients 106 is facilitated (e.g., managed) by the network transaction service 104. The network transaction service 104, for example, can implement a transfer of data (e.g., a data representation of value such as monetary value) to the transaction recipients 106 on behalf of the user device 102.

In at least some implementations and as described throughout this disclosure, instances of the transaction recipients 106 may not have an online presence where feedback regarding the transaction recipients 106 can be aggregated and shared among different users. Accordingly, the described techniques can be employed to aggregate feedback for the transaction recipients 106 via payment-related feedback that can be aggregated, converted to feedback data for the transaction recipients 106, and accessible to different users.

The transaction feedback service 108 represents a network-based service that can manage feedback regarding data transactions for various entities, such as the user device 102, the network transaction service 104, a transaction recipient 106, and so forth. For instance, when the user device 102 engages in a data transaction with a transaction recipient 106, the user 110 can utilize the user device 102 to provide feedback to the transaction feedback service 108 regarding the data transaction. The feedback, for example, can include data that identifies how the user 110 “rates” the data transaction, e.g., as a positive transaction, a satisfactory transaction, a negative transaction, etc.

The transaction feedback service 108 includes various data and functionality for aspects of feedback for transaction recipients, including user accounts 116, recipient accounts 118, and feedback levels 120. The user accounts 116 represent information indicating user feedback 122 for different users. The user accounts 116, for instance, include a user account 116 for the user 110 of the user device 102. The user accounts 116 include user feedback 122 that represents user feedback (e.g., ratings) for different data transactions. The recipient accounts 118 represent information regarding user feedback for different data transactions with the transaction recipients 106. For example, for instances of the transaction recipients 106, the transaction feedback service 108 maintains a respective recipient account 118 that includes respective recipient feedback 124 regarding data transactions associated with each of the instances of the transaction recipients 106. While the transaction feedback service 108 is illustrated as a separate entity than the network transaction service 104, in at least one implementation the transaction feedback service 108 can be implemented and/or managed by the network transaction service 104.

The feedback levels 120 represent different data categorizations of data transactions and transaction recipients 106, such as based on data transactions implemented between the user device 102 and the transaction recipients 106. The feedback levels 120, for example, include different predefined selectable categorizations that indicate a relative user feedback regarding instances of data transactions. In an example implementation the feedback levels 120 can be based on a scale of 1-10 with 1 indicating an extreme user dissatisfaction with a data transaction and 10 indicating an extreme user satisfaction with a data transaction.

The user device 102 includes a feedback application 126 which can enable the user 110 to interact with the user device 102 to provide feedback regarding data transactions. The feedback application 126, for instance, represents a portal to the transaction feedback service 108 that enables the user device 102 to communicate user feedback 122 to a user account 116 associated with the user device 102 and/or the user 110. Further, the user feedback 122 can be aggregated and converted into recipient feedback 124 for the transaction recipients 106.

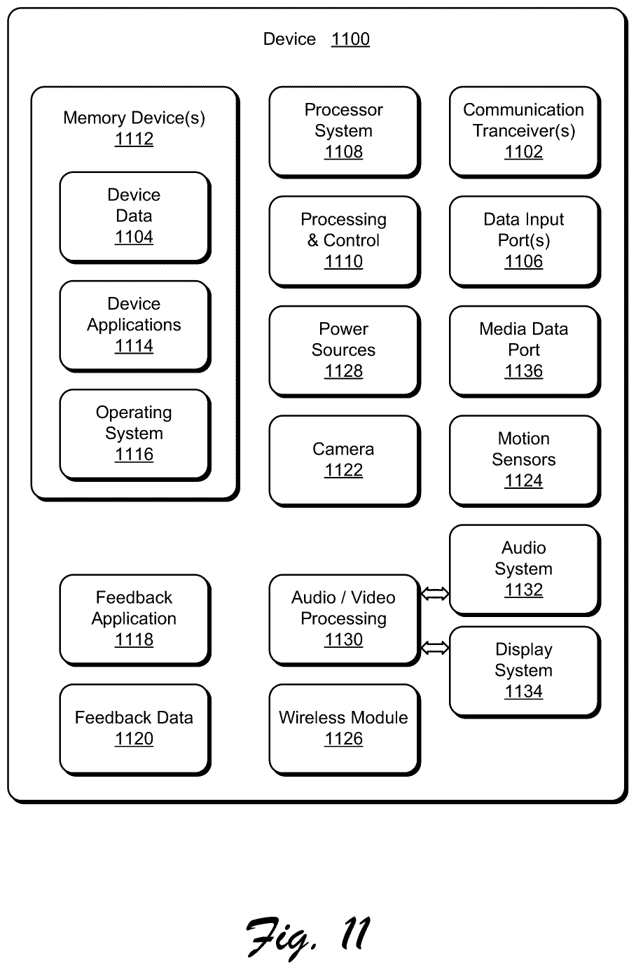

The user device 102, the network transaction service 104, the transaction feedback service 108, and/or the transaction recipients 106 can be implemented in various ways and include various functionality, examples of which are discussed below with reference to the example device 1100 of FIG. 11. Further, various entities of the environment 100 can be connected and communicate via a network 128. The network 128, for example, can represent a combination of wired and wireless networks via which the user device 102, the network transaction service 104, the transaction feedback service 108, and/or the transaction recipients 106 can participate in various types of communication, such as wired and/or wireless data communication.

Having discussed an example environment in which the disclosed techniques can be performed, consider now some example scenarios and implementation details for implementing the disclosed techniques.

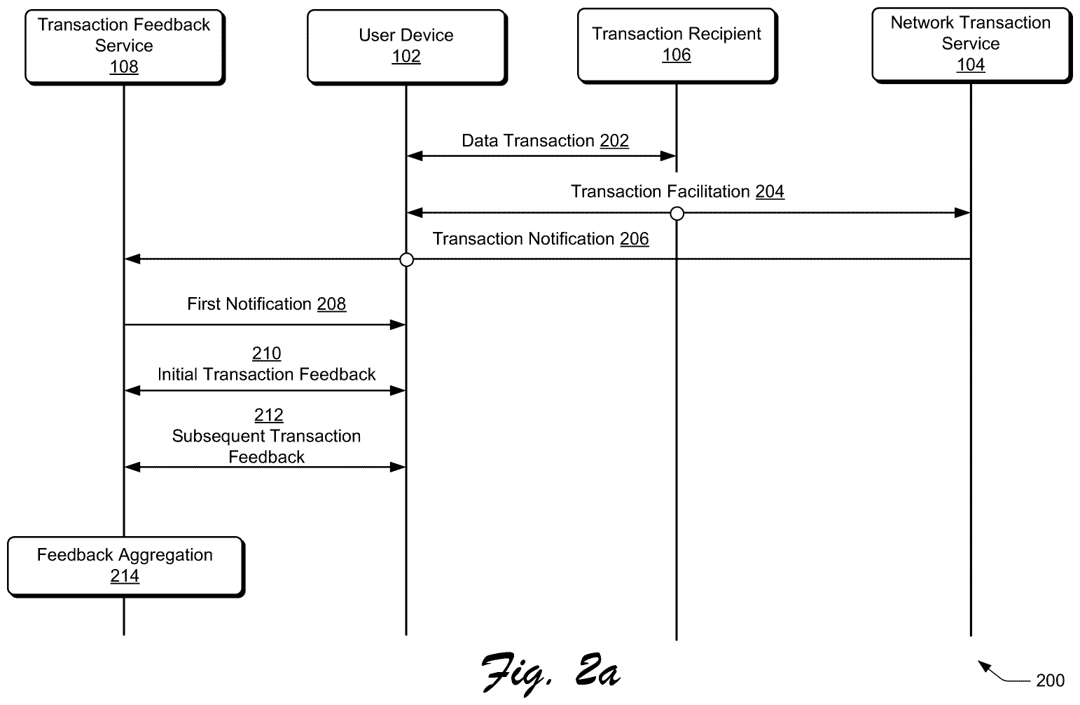

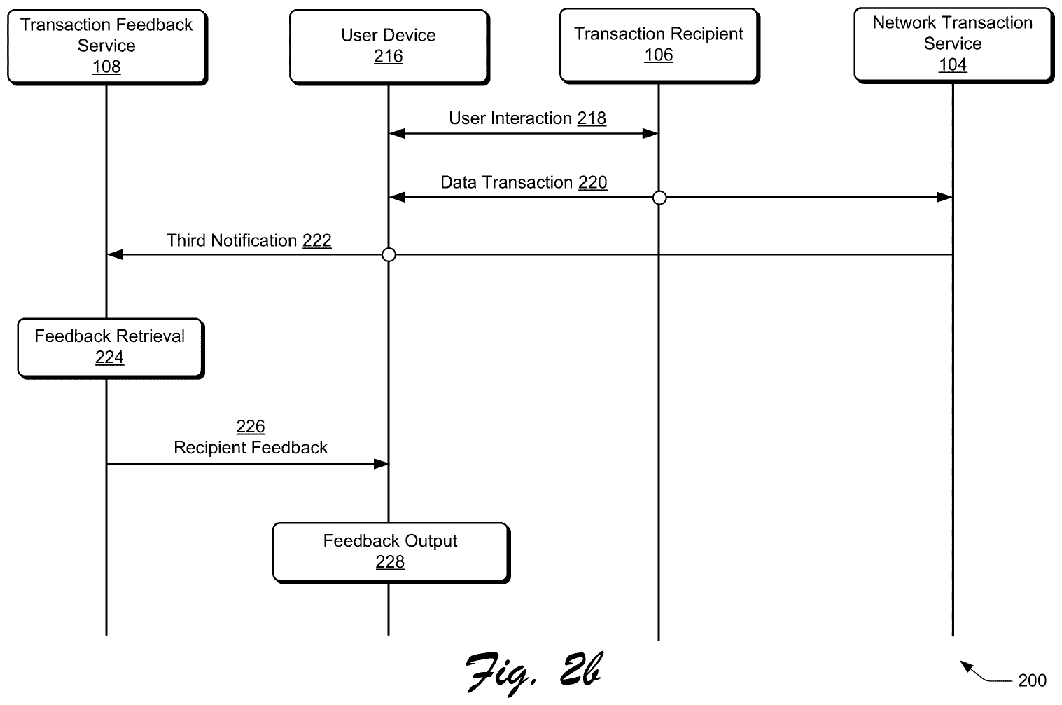

FIGS. 2a, 2b depict aspects of an example system 200 for feedback for transaction recipients in accordance with one or more implementations. The system 200 can be implemented in the environment 100 and incorporates attributes of the environment 100 introduced above.

FIG. 2a depicts aspects of the example system 200 for feedback for transaction recipients in accordance with one or more implementations. In the system 200, the user device 102 engages in a data transaction 202 with a transaction recipient 106. The data transaction 202 can represent various types of data-based transactions, such as an exchange of data, a finance transaction (e.g., an exchange of value for goods and/or services), and combinations thereof. In at least one implementation the data transaction 202 involves a provision of a product 114 by the transaction recipient 106 to the user 110 and a corresponding return of value from the user 110 to the transaction recipient 106.

The user device 102, the transaction recipient 106, and the network transaction service 104 participate in a transaction facilitation 204 which involves a transfer of data (e.g., data representing value) from the network transaction service 104 to the transaction recipient 106. For example, in the context of a finance transaction and as part of the transaction facilitation 204, the network transaction service 104 transfers a data representation of value (e.g., monetary value, digital currency, etc.) on behalf of the user device 102 to the transaction recipient 106.

Further to the system 200 a transaction notification 206 pertaining to the data transaction 202 is communicated to the transaction feedback service 108. The transaction notification 206 can include various information about the data transaction 202, such as an identifier of a user account 116 associated with the data transaction 202, an identifier of the user device 102, an identifier of the transaction recipient 106, an identifier of the network transaction service 104, a date and time at which the data transaction 202 is initiated and/or completed, a transaction type of the data transaction (e.g., a finance transaction, a data transfer transaction, etc.), and so forth. In the context of a finance transaction, the transaction notification 206 can include a value amount of the data transaction 202.

The transaction feedback service 108 can communicate a first notification 208 to the user device 102 that enables the user 110 to provide user feedback pertaining to the data transaction 202 via the user device 102. The first notification 208 can include various information pertaining to the data transaction 202, such as information described above with reference to the transaction notification 206. Further, the first notification 208 can include feedback indicia that are selectable to enable user feedback to be provided regarding the data transaction 202. The first notification 208 can be communicated to the user device 102 at various times related to the data transaction 202, such as while the data transaction 202 is pending, within a threshold time period after completion of the data transaction 202, after the threshold time period after completion of the data transaction 202, etc.

Further to the system 200 the user 110 can interact with the user device 102 to provide transaction feedback regarding the data transaction 202 to the transaction feedback service 108. For instance, the user device 102 can communicate initial transaction feedback 210 regarding the data transaction 202 to the transaction feedback service 108. The initial transaction feedback 210, for example, represents transaction feedback that is provided via the user device 102 while the data transaction 202 is pending and/or within a threshold time period from the data transaction 202. For instance, the initial transaction feedback 210 can be provided while the data transaction 202 and/or the transaction facilitation 204 are in progress (e.g., still pending), and/or the initial transaction feedback 210 can be provided within a threshold period of time such as within t minutes after conclusion of the data transaction 202 and/or the transaction facilitation 204.

Alternatively or additionally to the initial transaction feedback 210, the user device 102 can communicate subsequent transaction feedback 212 regarding the data transaction 202 to the transaction feedback service 108. The subsequent transaction feedback 212, for example, represents transaction feedback provided via the user device 102 after a threshold time period from the data transaction 202. For instance, the subsequent transaction feedback 212 can be provided after a threshold period of time such as after t minutes after conclusion of the data transaction 202 and/or the transaction facilitation 204.

Further to the system 200 the transaction feedback service 108 performs feedback aggregation 214 to aggregate transaction feedback including the initial transaction feedback 210 and/or the subsequent transaction feedback 212. The feedback aggregation 214, for instance, involves aggregating transaction feedback for multiple different data transactions involving the user device 102 and/or involving multiple different user devices and multiple different users. In implementations the feedback aggregation 214 can include aggregating transaction feedback regarding the transaction recipient 106 from multiple different users and regarding multiple different data transactions.

FIG. 2b depicts further aspects of the system 200 for enabling transaction feedback to be presented. For instance, a user device 216 engages in a user interaction 218 with the transaction recipient 106. In implementations the user device 216 can represent different user device than the user device 102 or may represent the user device 102. The user interaction 218 can represent different types of user interactions, such as a request from the user device 216 for feedback regarding the transaction recipient 106 and/or a data transaction 220 (e.g., a purchase of a product 114) between the user device 216 and the transaction recipient 106 that is facilitated by the network transaction service 104.

Based at least in part on the user interaction 218 and/or the data transaction 220 a third notification 222 requesting feedback regarding the transaction recipient 106 is communicated to the transaction feedback service 108. The third notification 22 may be communicated by the user device 216 and/or the network transaction service 104, such as in conjunction with the data transaction 220 between the user device 216 and the transaction recipient 106 that is facilitated by the network transaction service 104.

Accordingly, the transaction feedback service 108 performs feedback retrieval 224 to gather user feedback regarding the transaction recipient 106, such as based on aggregated user feedback from multiple different data transactions involving the transaction recipient 106. The transaction feedback service 108 then communicates recipient feedback 226 to the user device 216 based at least in part on the feedback retrieval 224. The recipient feedback 226, for example, can include an indication of transaction feedback for the transaction recipient 106, such as a summary of transaction feedback. The user device 216 can then perform feedback output 228 to present the recipient feedback 226 on the user device 216, such as via visual output, audible output, tactile output, and/or combinations thereof.

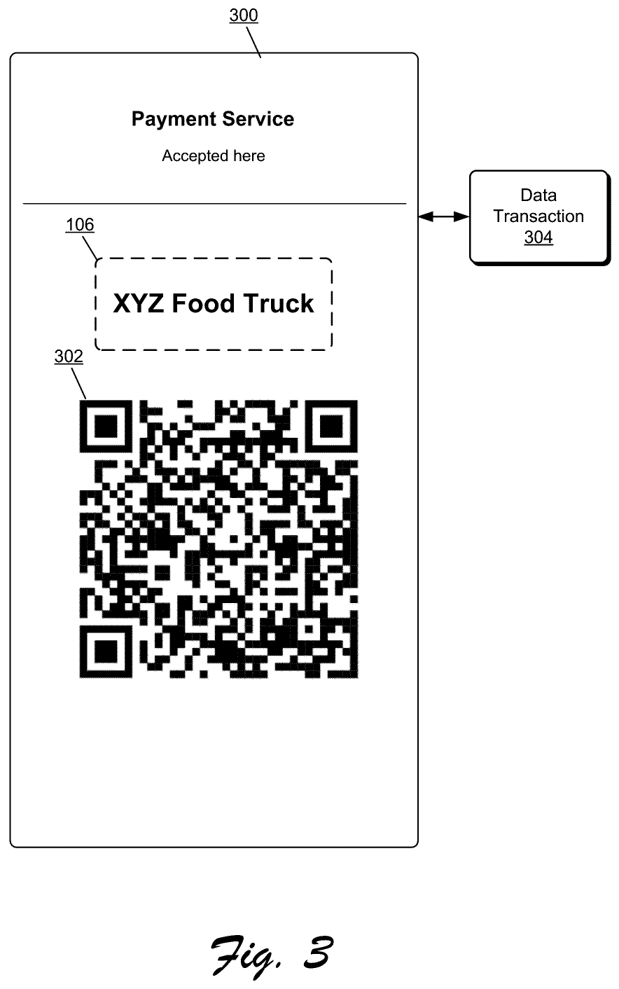

FIG. 3 depicts an example payment indicator 300 in accordance with one or more implementations. The payment indicator 300, for instance, is presented for a transaction recipient 106 and may be presented in different ways, such as via a digital display, via a printed physical document displayed at a location of the transaction recipient, user entry of a physical address of the transaction recipient, etc. The payment indicator 300 includes encoded data 302 that is scannable to enable a data transaction to be performed between the user device 102 and the transaction recipient 106. In this particular example the encoded data 302 represents a quick response (QR) code. This is not to be construed as limiting, however, and the encoded data 302 can be implemented in various ways, such as other forms of optically encoded data, wirelessly transmitted encoded data (e.g., radio frequency (RF) transmitted encoded data), encoded data transmitted via light transmission (e.g., infrared transmitted data), etc. Thus, the user 110 can utilize the user device 102 to scan the encoded data 302 to perform a data transaction 304 (e.g., a payment transaction) with the transaction recipient 106.

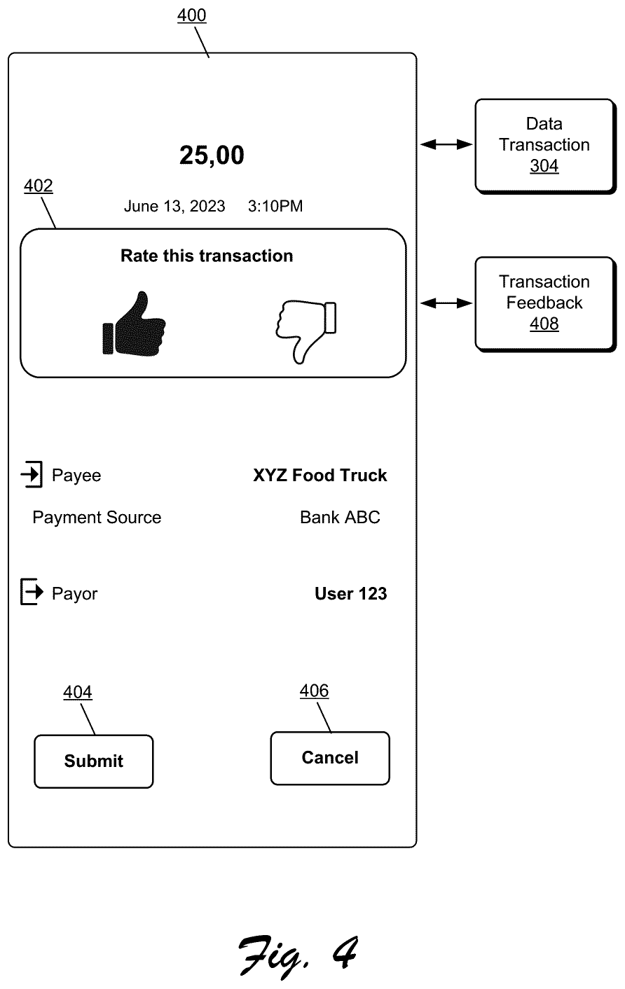

FIG. 4 depicts an example payment graphical user interface (GUI) 400 in accordance with one or more implementations. The payment GUI 400, for example, is presented by the network transaction service 104 via the transaction application 112 on the user device 102 and in response to the user device 102 scanning the encoded data 302 described above. The payment GUI 400 includes various information about the data transaction 304, such as a transaction amount, a payee identifier (XYZ Food Truck), a payor identifier (User 123, e.g., the user 110), a date and time of the data transaction 304, etc.

The payment GUI 400 also includes a feedback control 402, a submit control 404, and a cancel control 406. The feedback control 402 includes selectable feedback indicia that are selectable to provide feedback regarding the data transaction 304. For instance, a thumbs up indicator is selectable to indicate positive feedback regarding the data transaction 304 and a thumbs down indicator is selectable to provide negative feedback regarding the data transaction 304. In this particular example the thumbs up indicator is selected to generate transaction feedback 408 regarding the data transaction 304.

The submit control 404 is selectable to complete the data transaction 304, e.g., a transfer of value from a user account 116 of the user 110 to the transaction recipient 106. Further, selecting the submit control 404 can cause the transaction feedback 408 to be communicated to the transaction feedback service 108. The cancel control 406 is selectable to cancel the data transaction 304, e.g., to terminate the data transaction 304 prior to completion.

In at least one implementation even if the cancel control 406 is selected and the data transaction 304 canceled, the transaction feedback 408 can be communicated to the transaction feedback service 108. For instance, where the user 110 has a negative experience with the transaction recipient 106 as part of the data transaction 304, the user 110 can indicate negative feedback to the feedback control 402 and select the cancel control 406 to cancel the data transaction 304. The transaction feedback 408 indicating the negative feedback can then be communicated to the transaction feedback service 108.

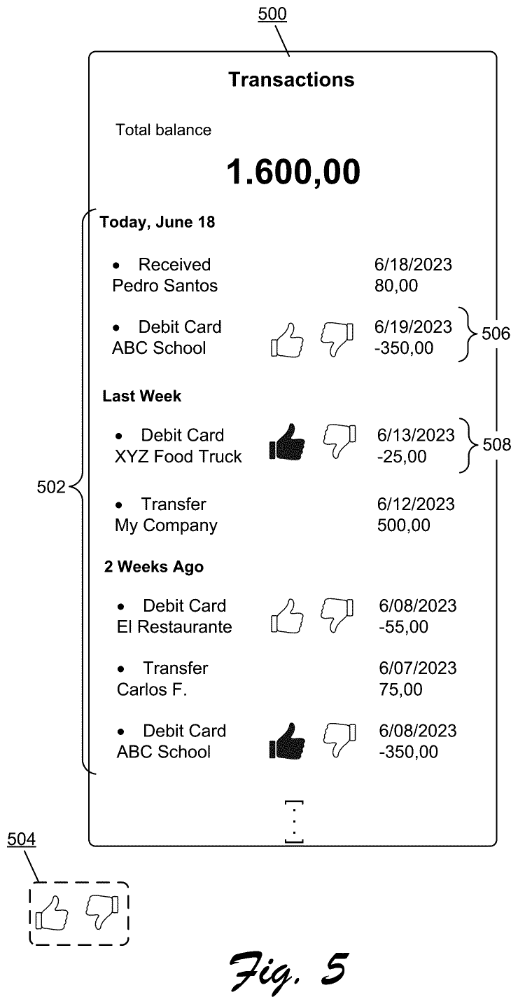

FIG. 5 depicts an example transactions GUI 500 in accordance with one or more implementations. The transactions GUI 500, for instance, presents a history of data transactions of a particular user, such as the user 110. The transactions GUI 500 includes a transactions region 502 that includes different transaction entries for data transactions, such as transaction details for different data transactions. Further, at least some of the transaction entries include feedback indicia 504 that indicate previous feedback provided for data transactions and/or that are selectable to provide feedback for previous data transactions.

For instance, a transaction entry 506 includes feedback indicia 504 that indicate that transaction feedback has not been provided for an associated data transaction, and the feedback indicia 504 are selectable to provide transaction feedback. A transaction entry 508 includes feedback indicia 504 that indicate that transaction feedback (thumbs up) has previously been provided for an associated data transaction. The transaction entry 508, for instance, represents the data transaction 304 introduced above. According to implementations, transaction feedback provided to the transactions GUI 500 can be communicated to the transaction feedback service 108 for aggregating transaction feedback for different instances of transaction recipients.

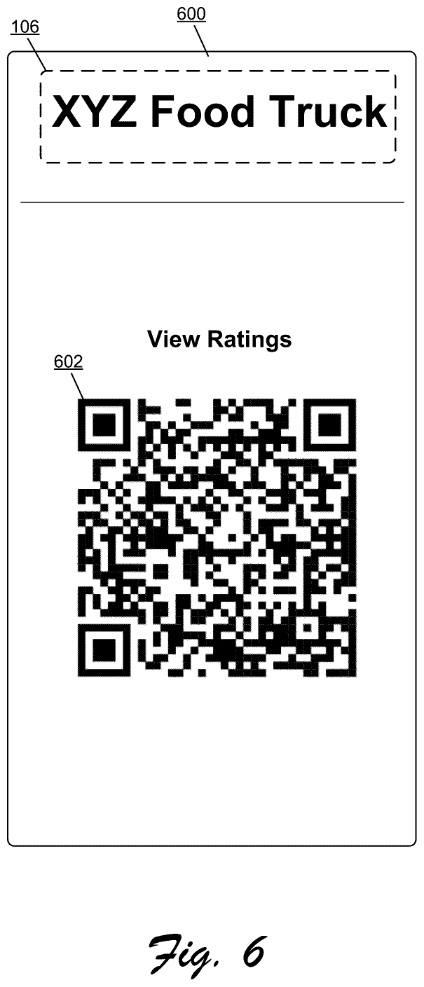

FIG. 6 depicts an example feedback indicator 600 in accordance with one or more implementations. The feedback indicator 600, for instance, enables feedback for a transaction recipient 106 to be obtained. The feedback indicator 600 can be presented in different ways, such as via a digital display, via a printed physical document displayed at a location of the transaction recipient, etc.

The feedback indicator 600 identifies the transaction recipient 106 (“XYZ Food Truck”) and includes encoded data 602 that can be scanned to obtain feedback regarding the transaction recipient 106. In this particular example the encoded data 602 represents a QR code, but the encoded data 602 can be implemented in a variety of different ways. In implementations aggregated user feedback and a payment to a transaction recipient can be triggered by the scanning of a same QR code, such as the encoded data 302, 602 depicted in FIGS. 3, 6.

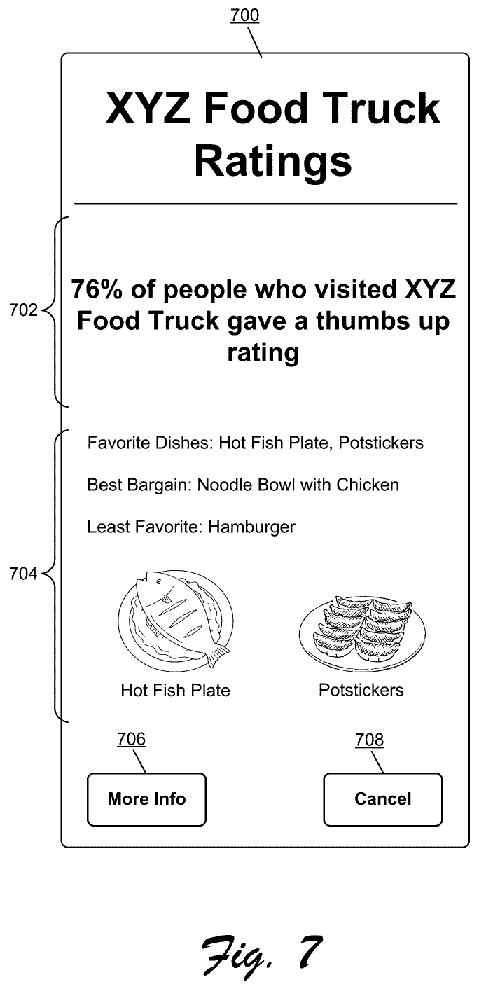

FIG. 7 depicts an example feedback GUI 700 in accordance with one or more implementations. The feedback GUI 700, for instance, is presented via the user device 102 in response to scanning the encoded data 602 introduced above. The feedback GUI 700 identifies the transaction recipient 106 and includes a feedback region 702, a details region 704, a more information control 706, and a cancel control 708. The feedback region 702 includes an indication of user feedback associated with the transaction recipient 106, such as based on user feedback regarding data transactions (e.g., purchase transactions) with the transaction recipient 106. The feedback region 702, for example, provides a summary of transaction feedback, such as a natural language overview of user feedback regarding data transactions with the transaction recipient 106.

The details region 704 includes various details obtained from user feedback regarding the transaction recipient 106, such as favorite products, products with the best value, least favorite products, product images, etc. The more information control 706 is selectable to obtain more information about the user feedback regarding the transaction recipient 106 and/or the transaction recipient 106 itself, and the cancel control 708 is selectable to remove the feedback GUI 700 from display.

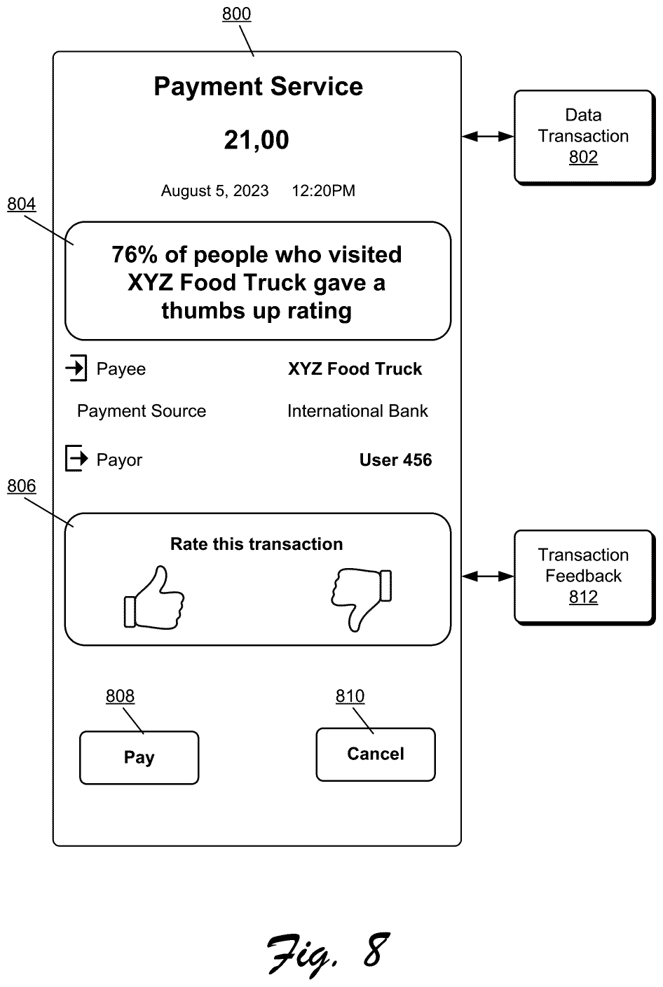

FIG. 8 depicts an example payment GUI 800 in accordance with one or more implementations. The payment GUI 800, for example, is presented by the network transaction service 104 via the transaction application 112 on the user device 102 and in response to the user 110 initiating a data transaction 802 with the transaction recipient 106. The data transaction 802, for instance, represents a purchase of one or more products from the transaction recipient 106. The payment GUI 800 includes various information about the data transaction 802, such as a transaction amount, a payee identifier (XYZ Food Truck), a payor identifier (User 456), a date and time of the data transaction 802, etc.

The payment GUI 800 also includes a feedback region 804, a feedback control 806, a pay control 808, and a cancel control 810. The feedback region 804 includes an indication of historic user feedback regarding the transaction recipient 106, such as a summary of user feedback from different users regarding data transactions with the transaction recipient 106. The feedback control 806 is configured to receive user interaction to provide transaction feedback for a current data transaction, e.g., the data transaction 802. For instance, a user can select a feedback indicia from the feedback control 806 to generate transaction feedback 812 regarding the data transaction 802.

The pay control 808 is selectable to complete the data transaction 802, such as to cause a transfer of data representing value from a user account to an account of the transaction recipient 106. The cancel control 810 is selectable to cancel the data transaction 802, e.g., to terminate the data transaction prior to completion. Further, and as discussed above, the transaction feedback 812 can be communicated to the transaction feedback service 108 in either case, e.g., whether the user selects the pay control 808 or selects the cancel control 810.

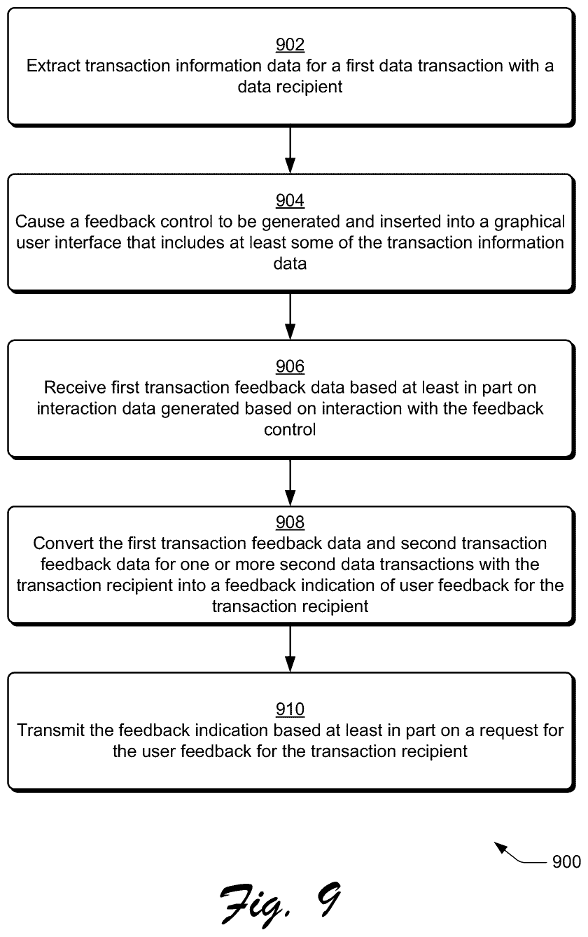

FIG. 9 illustrates a flow chart depicting an example method 900 for feedback for transaction recipients in accordance with one or more implementations. Operations of the method 900, for instance, may be performed in the context of the environment 100, such as by the transaction feedback service 108.

At 902 transaction information data is extracted for a first data transaction with a transaction recipient. For instance, the transaction feedback service 108 extracts information about a data transaction of the user device 102, such as a data transaction between the user device 102 and a transaction recipient 106. In at least one implementation the transaction information data can be extracted via interaction between the transaction feedback service 108 and the network transaction service 104 which facilitates the data transaction. The transaction information data can include various information about the first data transaction, such as identifier of the transaction recipient 106, an identifier of a user account associated with the user device 102, a value amount of the data transaction, etc. In at least one implementation the transaction information can be extracted in response to receiving transaction data indicating an initiation of a data transaction (e.g., a payment transaction) between a user account and a transaction recipient.

At 904 a feedback control is caused to be generated and inserted into a graphical user interface that includes at least some of the transaction information data. The graphical user interface, for instance, represents a GUI for a payment transaction and/or a transaction GUI for historical payment transactions, examples of which are described throughout this disclosure. In at least one implementation the transaction feedback service 108 communicates an instruction to the user device 102 (e.g., to the transaction application 112 and/or the feedback application 126) to insert a feedback control into the GUI.

At 906 first transaction feedback data is received based at least in part on interaction data generated based on interaction with the feedback control. The user 110, for instance, interacts with the feedback control to provide transaction feedback and transaction feedback data for the transaction feedback is transmitted to the transaction feedback service 108.

At 908 the first transaction feedback data and second transaction feedback data for one or more second data transactions with the transaction recipient are converted into a feedback indication of user feedback for the transaction recipient. For instance, transaction feedback data for multiple different data transactions by multiple different users is converted from transaction feedback data for individual data transactions into user feedback data for a transaction recipient, e.g., a single instance of a transaction recipient. This is not to be construed as limiting, however, and this process can be performed for multiple different transaction recipients to generate user feedback for multiple different instances of transaction recipients 106.

At 910 the feedback indication is transmitted based at least in part on a request for the user feedback for the transaction recipient. The transaction feedback service 108, for instance, can receive a request from the user device 102 and/or the network transaction service 104 for user feedback for a transaction recipient 106. The request for the user feedback for the transaction recipient can be generated based on various events, such as a subsequent data transaction initiated with the transaction recipient, an express user request for the user feedback, a scan of encoded data associated with the transaction recipient, etc. In response the transaction feedback service 108 can transmit the feedback indication.

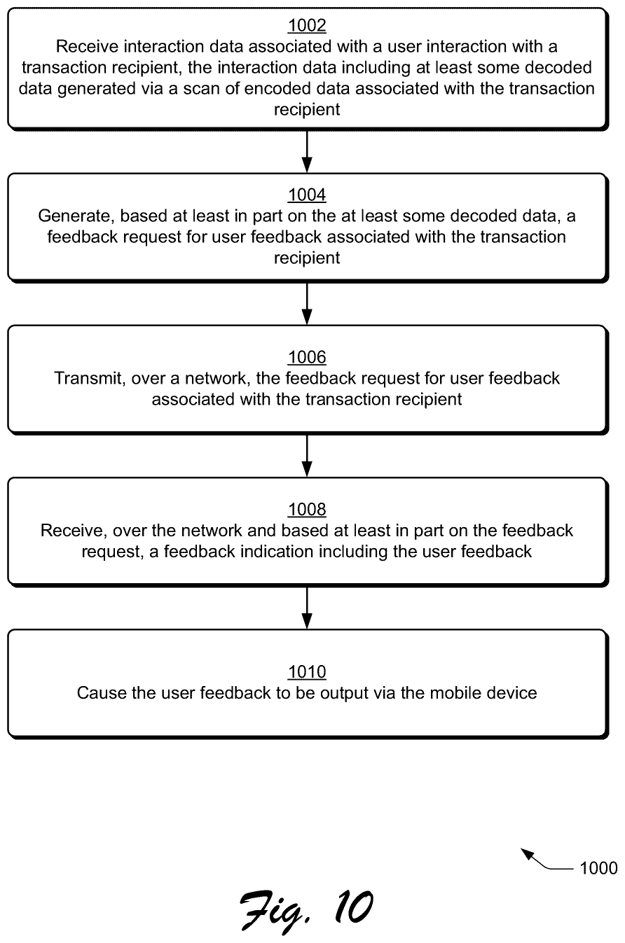

FIG. 10 illustrates a flow chart depicting an example method 1000 for feedback for transaction recipients in accordance with one or more implementations. Operations of the method 1000, for instance, may be performed in the context of the environment 100, such as by the user device 102, the transaction application 112, and/or the feedback application 126.

At 1002 interaction data associated with a user interaction with a transaction recipient is received, the interaction data including at least some decoded data generated via a scan of encoded data associated with the transaction recipient. For instance, the user interaction can be based on a user utilizing the user device 102 to scan encoded data (e.g., a QR code and/or other form of encoded data) to initiate a data transaction with a transaction recipient 106. Alternatively or additionally, the user interaction can be based on a user expressly requesting user feedback for the transaction recipient 106, such as via a scan of encoded data (e.g., a QR code) that triggers a request for user feedback regarding the transaction recipient 106. In at least some implementations a same encoded data (e.g., QR code) can be used to initiate a data transaction and request user feedback for a transaction recipient 106.

At 1004 and based at least in part on the at least some decoded data, a feedback request is generated for user feedback associated with the transaction recipient. The decoded data, for example, can cause a feedback request for user feedback to be generated via the user device 102. At 1006 the feedback request for user feedback associated with the transaction recipient is transmitted over a network. The feedback request, for instance, is transmitted by the user device 102 to the transaction feedback service 108.

At 1008 and based at least in part on the feedback request, a feedback indication including the user feedback is received over the network. The transaction feedback service 108, for instance, transmits the feedback indication including user feedback regarding the transaction recipient 106 to the user device 102. At 1010 the user feedback is caused to be output via the mobile device. The user device 102, for instance, outputs the user feedback regarding the transaction recipient 106. The user feedback can be output in various ways, such as by inserting the user feedback into a payment graphical user interface of the data transaction, by inserting the user feedback into a feedback graphical user interface of the mobile device, etc.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 11 illustrates various components of an example device 1100 in which aspects of feedback for transaction recipients can be implemented. The example device 1100 can be implemented as any of the devices described with reference to the previous FIGS. 1-10, such as any type of mobile device, mobile phone, mobile device, wearable device, tablet, computing, communication, entertainment, gaming, media playback, and/or other type of electronic device. For example, the user device 102 and/or the transaction feedback service 108 as shown and described with reference to FIGS. 1-11 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like). Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a feedback application 1118 that implements aspects of feedback for transaction recipients and may be implemented with hardware components and/or in software as one of the device applications 1114. For example, the feedback application 1118 can be implemented via the user device 102 and/or the transaction feedback service 108. In implementations, the feedback application 1118 may include independent processing, memory, and logic components as a computing and/or electronic device integrated with the device 1100. The device 1100 also includes feedback data 1120 for implementing aspects of feedback for transaction recipients and may include data from the feedback application 1118, such as data for managing data transaction feedback.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of feedback for transaction recipients have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a system including: at least one memory; and at least one processor coupled to the at least one memory and configured to cause the system to: extract transaction information data for a first data transaction with a transaction recipient; cause a feedback control to be generated and inserted into a graphical user interface that includes at least some of the transaction information data; receive first transaction feedback data based at least in part on interaction data generated based on interaction with the feedback control; convert the first transaction feedback data and second transaction feedback data for one or more second data transactions with the transaction recipient into a feedback indication of user feedback for the transaction recipient; and transmit the feedback indication based at least in part on a request for the user feedback for the transaction recipient.

In some aspects, the techniques described herein relate to a system, wherein the first data transaction includes one or more of a finance transaction or a transaction pertaining to user data.

In some aspects, the techniques described herein relate to a system, wherein the transaction recipient includes an entity that does not maintain a dedicated online presence.

In some aspects, the techniques described herein relate to a system, wherein first data transaction includes one or more of a pending data transaction or a historical data transaction.

In some aspects, the techniques described herein relate to a system, wherein the first data transaction is associated with a user account, and the graphical user interface includes one or more of a payment graphical user interface for the pending data transaction or a transaction graphical user interface that identifies the first data transaction and one or more other historical data transactions associated with the user account.

In some aspects, the techniques described herein relate to a system, wherein the at least one processor is configured to cause the system to: generate a recipient account for the transaction recipient; and store the first transaction feedback data and the second transaction feedback data as part of the recipient account.

In some aspects, the techniques described herein relate to a system, wherein the at least one processor is configured to cause the system to extract the transaction information data and cause the feedback control to be generated and inserted into the graphical user interface in response to an indication that encoded data pertaining to the first data transaction is scanned.

In some aspects, the techniques described herein relate to a system, wherein the request for the user feedback for the transaction recipient is generated based on one or more of a third data transaction initiated with the transaction recipient or a scan of encoded data associated with the transaction recipient.

In some aspects, the techniques described herein relate to a system, wherein the at least one processor is configured to cause the system to transmit an instruction to insert the feedback indication into one or more of a payment graphical user interface for the third data transaction or a feedback graphical user interface associated with the scan of the encoded data.

In some aspects, the techniques described herein relate to a mobile device including: at least one module; and at least one processor that is configured to execute the at least one module to cause the mobile device to: receive interaction data associated with a user interaction with a transaction recipient, the interaction data including at least some decoded data generated via a scan of encoded data associated with the transaction recipient; generate, based at least in part on the at least some decoded data, a feedback request for user feedback associated with the transaction recipient; transmit, over a network, the feedback request for user feedback associated with the transaction recipient; receive, over the network and based at least in part on the feedback request, a feedback indication including the user feedback; and cause the user feedback to be output via the mobile device.

In some aspects, the techniques described herein relate to a mobile device, wherein the interaction data includes an indication that the user interaction includes one or more of an initiation of a data transaction with the transaction recipient or a user request for user feedback associated with the transaction recipient.

In some aspects, the techniques described herein relate to a mobile device, wherein the user interaction includes a data transaction between the mobile device and the transaction recipient, and the at least one processor is configured to execute the at least one module to cause the mobile device to insert the user feedback into a payment graphical user interface of the data transaction.

In some aspects, the techniques described herein relate to a mobile device, wherein the user interaction includes a user request for user feedback associated with the transaction recipient, and wherein the at least one processor is configured to execute the at least one module to cause the mobile device to insert the user feedback into a feedback graphical user interface of the mobile device.

In some aspects, the techniques described herein relate to a mobile device, wherein the mobile device is associated with a user account, and wherein the at least one processor is configured to execute the at least one module to cause the mobile device to: present a transaction graphical user interface that identifies data transactions for the user account and includes feedback indicia for one or more of the data transactions; receive user input to feedback indicia to provide user feedback for a data transaction with the transaction recipient; and transmit, to a feedback service, the user feedback for the data transaction with the transaction recipient.

In some aspects, the techniques described herein relate to a mobile device, wherein the user interaction includes initiation of a data transaction between the mobile device and the transaction recipient, and the at least one processor is configured to execute the at least one module to cause the mobile device to: receive an indication of user input of transaction feedback regarding the data transaction to a graphical user interface for the data transaction; and transmit the transaction feedback to a feedback service.

In some aspects, the techniques described herein relate to a mobile device, wherein the user interaction includes initiation of a data transaction between the mobile device and the transaction recipient, and the at least one processor is configured to execute the at least one module to cause the mobile device to: receive an indication of user input of transaction feedback regarding the data transaction to a graphical user interface for the data transaction: receive an indication of user cancellation of the data transaction prior to completion of the data transaction; and transmit the transaction feedback to a feedback service.

In some aspects, the techniques described herein relate to a mobile device, wherein the at least one processor is configured to execute the at least one module to cause the mobile device to receive the indication of user input of the transaction feedback at one or more of while the data transaction is pending or within a threshold time period after conclusion of the data transaction.

In some aspects, the techniques described herein relate to a method including: receiving transaction data indicating an initiation of a data transaction between a user account and a transaction recipient; causing a feedback control to be generated and inserted into a graphical user interface for the data transaction; receiving first transaction feedback data based at least in part on interaction data generated based on interaction with the feedback control; converting the first transaction feedback data and second transaction feedback data for one or more second data transactions with the transaction recipient into a feedback indication of user feedback for the transaction recipient; and transmitting the feedback indication based at least in part on a request for the user feedback for the transaction recipient.

In some aspects, the techniques described herein relate to a method, wherein causing a feedback control to be generated and inserted into a graphical user interface for the data transaction includes one or more of: causing the feedback control to be inserted into the graphical user interface while the data transaction is pending: or causing the feedback control to be inserted into the graphical user interface within a threshold time period after conclusion of the data transaction.

In some aspects, the techniques described herein relate to a method, wherein the request for the user feedback for the transaction recipient is based on one or more of an initiation of a second data transaction with the transaction recipient or decoded data generated from a scan of encoded data associated with the transaction recipient.

1. A system comprising:
at least one memory; and
at least one processor coupled to the at least one memory and configured to cause the system to:
extract transaction information data for a first data transaction with a transaction recipient;
cause a feedback control to be generated and inserted into a graphical user interface that includes at least some of the transaction information data;
receive first transaction feedback data based at least in part on interaction data generated based on interaction with the feedback control;
convert the first transaction feedback data and second transaction feedback data for one or more second data transactions with the transaction recipient into a feedback indication of user feedback for the transaction recipient; and
transmit the feedback indication based at least in part on a request for the user feedback for the transaction recipient.

2. The system of claim 1, wherein the first data transaction comprises one or more of a finance transaction or a transaction pertaining to user data.

3. The system of claim 1, wherein the transaction recipient comprises an entity that does not maintain a dedicated online presence.

4. The system of claim 1, wherein first data transaction comprises one or more of a pending data transaction or a historical data transaction.

5. The system of claim 4, wherein the first data transaction is associated with a user account, and the graphical user interface comprises one or more of a payment graphical user interface for the pending data transaction or a transaction graphical user interface that identifies the first data transaction and one or more other historical data transactions associated with the user account.

6. The system of claim 1, wherein the at least one processor is configured to cause the system to:
generate a recipient account for the transaction recipient; and
store the first transaction feedback data and the second transaction feedback data as part of the recipient account.

7. The system of claim 1, wherein the at least one processor is configured to cause the system to extract the transaction information data and cause the feedback control to be generated and inserted into the graphical user interface in response to an indication that encoded data pertaining to the first data transaction is scanned.

8. The system of claim 1, wherein the request for the user feedback for the transaction recipient is generated based on one or more of a third data transaction initiated with the transaction recipient or a scan of encoded data associated with the transaction recipient.

9. The system of claim 8, wherein the at least one processor is configured to cause the system to transmit an instruction to insert the feedback indication into one or more of a payment graphical user interface for the third data transaction or a feedback graphical user interface associated with the scan of the encoded data.

10. A mobile device comprising:
at least one module; and
at least one processor that is configured to execute the at least one module to cause the mobile device to:
receive interaction data associated with a user interaction with a transaction recipient, the interaction data including at least some decoded data generated via a scan of encoded data associated with the transaction recipient;
generate, based at least in part on the at least some decoded data, a feedback request for user feedback associated with the transaction recipient;
transmit, over a network, the feedback request for user feedback associated with the transaction recipient;
receive, over the network and based at least in part on the feedback request, a feedback indication including the user feedback; and
cause the user feedback to be output via the mobile device.

11. The mobile device of claim 10, wherein the interaction data comprises an indication that the user interaction comprises one or more of an initiation of a data transaction with the transaction recipient or a user request for user feedback associated with the transaction recipient.

12. The mobile device of claim 10, wherein the user interaction comprises a data transaction between the mobile device and the transaction recipient, and the at least one processor is configured to execute the at least one module to cause the mobile device to insert the user feedback into a payment graphical user interface of the data transaction.

13. The mobile device of claim 10, wherein the user interaction comprises a user request for user feedback associated with the transaction recipient, and wherein the at least one processor is configured to execute the at least one module to cause the mobile device to insert the user feedback into a feedback graphical user interface of the mobile device.

14. The mobile device of claim 10, wherein the mobile device is associated with a user account, and wherein the at least one processor is configured to execute the at least one module to cause the mobile device to:
present a transaction graphical user interface that identifies data transactions for the user account and includes feedback indicia for one or more of the data transactions;
receive user input to feedback indicia to provide user feedback for a data transaction with the transaction recipient; and
transmit, to a feedback service, the user feedback for the data transaction with the transaction recipient.

15. The mobile device of claim 10, wherein the user interaction comprises initiation of a data transaction between the mobile device and the transaction recipient, and the at least one processor is configured to execute the at least one module to cause the mobile device to:
receive an indication of user input of transaction feedback regarding the data transaction to a graphical user interface for the data transaction; and
transmit the transaction feedback to a feedback service.

16. The mobile device of claim 10, wherein the user interaction comprises initiation of a data transaction between the mobile device and the transaction recipient, and the at least one processor is configured to execute the at least one module to cause the mobile device to:
receive an indication of user input of transaction feedback regarding the data transaction to a graphical user interface for the data transaction;
receive an indication of user cancellation of the data transaction prior to completion of the data transaction; and
transmit the transaction feedback to a feedback service.

17. The mobile device of claim 15, wherein the at least one processor is configured to execute the at least one module to cause the mobile device to receive the indication of user input of the transaction feedback at one or more of while the data transaction is pending or within a threshold time period after conclusion of the data transaction.

18. A method comprising:
receiving transaction data indicating an initiation of a data transaction between a user account and a transaction recipient;
causing a feedback control to be generated and inserted into a graphical user interface for the data transaction;
receiving first transaction feedback data based at least in part on interaction data generated based on interaction with the feedback control;
converting the first transaction feedback data and second transaction feedback data for one or more second data transactions with the transaction recipient into a feedback indication of user feedback for the transaction recipient; and
transmitting the feedback indication based at least in part on a request for the user feedback for the transaction recipient.

19. The method of claim 18, wherein causing a feedback control to be generated and inserted into a graphical user interface for the data transaction comprises one or more of:
causing the feedback control to be inserted into the graphical user interface while the data transaction is pending; or
causing the feedback control to be inserted into the graphical user interface within a threshold time period after conclusion of the data transaction.

20. The method of claim 18, wherein the request for the user feedback for the transaction recipient is based on one or more of an initiation of a second data transaction with the transaction recipient or decoded data generated from a scan of encoded data associated with the transaction recipient.
